(19) United States
(12) Patent Application Publication
(10) Pub. No.: US 2013/0166464 A1
(43) Pub. Date: Jun. 27, 2013

(54) METHODS AND SYSTEMS TO AUTHENTICATE A PRINTED MEDIUM

(71) Applicants: Mary Lee Schneider, Chicago, IL (US); Steven Todd Berlin, Buffalo Grove, IL (US); Candice L. Harold, Riverwoods, IL (US); Eric M. Wood, Schaumburg, IL (US)

(72) Inventors: Mary Lee Schneider, Chicago, IL (US); Steven Todd Berlin, Buffalo Grove, IL (US); Candice L. Harold, Riverwoods, IL (US); Eric M. Wood, Schaumburg, IL (US)

(21) Appl. No.: 13/333,606

(22) Filed: Dec. 21, 2011

(51) Int. Cl. G06Q 30/00

(52) U.S. Cl. 705/318; 235/375

(57) ABSTRACT

Examples to prevent the return of a printed medium and to authorize access to supplemental material to a printed medium upon resale of the printed medium are described. An example method of preventing the return of a printed medium including a product identification code and a unique identification code includes verifying the authenticity of the unique identification code against a database of genuine unique identification codes. The product identification code identifies a type of printed medium, and the unique identification code is associated with the printed medium and not associated with other printed media having the same product identification code. The example method also includes providing a clearance status based on the verification, which authorizes the return of the printed medium when the unique identification code is valid and denies the return of the printed medium when the unique identification code is invalid.

### FIELD OF THE DISCLOSURE

The present disclosure relates generally to printed media and more particularly to methods and systems to authenticate a printed medium.

### BACKGROUND

Printed media, for example textbooks, typically have product identification numbers associated with them. When a retailer fails to sell all the books in its inventory within a specific time period, the retailer will typically send the unsold books back to the publisher for a credit. It is easy for unscrupulous people to counterfeit books with the product identification numbers and then return them for credit.

In addition, some printed media contain information for accessing supplemental media. For example, a college textbook could have a code to access further practice questions online. Deceitful people may sell counterfeit books with the codes for accessing supplemental material, and students may also distribute the codes to their friends, which enables people to access the supplemental material without paying the original publisher and author.

### BRIEF DESCRIPTION OF THE DRAWINGS

FIG. 1 is a block diagram of an example system to authenticate a printed medium.

FIG. 2 is a block diagram of an example printed medium.

FIG. 3 is a flow chart of an example method to authenticate a printed medium.

FIG. 4 is a flow chart of an example method to provide supplemental material access authorization.

FIG. 5 is an example processor platform capable of implementing the example system of FIG. 1 and/or the methods of FIGS. 3 and/or 4.

### DETAILED DESCRIPTION

The following description of the disclosed examples is not intended to limit the scope of the disclosure to the precise form or forms detailed herein. Instead, the following description is intended to be illustrative of the principles of the disclosure.

Disclosed herein are example methods, apparatus and articles of manufacture to track authorized reproduction(s) of proprietary materials including, for example, copyrighted materials. The example described herein allow for the identification of lawfully and unlawfully reproduced copies of printed media, which deters counterfeiting and may be used to prevent the return of a printed medium. In addition, some examples described herein authorize access to supplemental material to a printed medium upon resale of the printed medium. An example method of preventing the return of a printed medium includes upon the attempted return of a printed medium including a product identification code and a unique identification code separate from the product identification code, verifying the inclusion of the unique identification code in a database of a plurality of genuine unique identification codes to verify the authenticity of the unique identification code. The product identification code identifies a type of printed medium, and the unique identification code is associated with the printed medium and not associated with other printed media having the same product identification code. The example method also includes providing a clearance status based on the verification. The clearance status authorizes the return of the printed medium when the unique identification code is valid, and the clearance status denies the return of the printed medium when the unique identification code is invalid.

An example system to prevent the return of a printed medium disclosed herein includes a generator to generate a unique identification code for inclusion with a printed medium including a product identification code. The unique identification code is separate from the product identification code, the product identification code identifies a type of printed medium, and the unique identification code is associated with the printed medium and not associated with other printed media having the same product identification code. The example system also includes a database to store the plurality of genuine unique identification codes and a verifier to compare the unique identification of the printed medium upon the attempted return of the printed medium with the plurality of genuine unique identification codes in the database to determine if the unique identification code is included in the database. The verifier also provides a clearance status to authorize the return of the printed medium when the unique identification code appears in the database and to deny the return of the printed medium when the unique identification code does not appear in the database.

Also disclosed herein are tangible machine readable media having instructions stored thereon, which when executed, cause method to at least generate a unique identification code for inclusion with a printed medium including a product identification code. In this example, as in the examples noted above, the unique identification code is separate from the product identification code, the product identification code identifies a type of printed medium and the unique identification code is associated with the printed medium and not associated with other printed media having the same product identification code. The example instructions, when executed, also cause a machine to compare the unique identification of the printed medium upon the attempted return of the printed medium with a plurality of genuine unique identification codes stored in a database to determine if the unique identification code is included in the database and to provide a clearance status to authorize the return of the printed medium when the unique identification code appears in the database and to deny the return of the printed medium when the unique identification code does not appear in the database.

The examples disclosed herein also detail an example method of authorizing access to supplemental material to a printed medium upon resale of the printed medium. The example method includes including a first unique identification code with the printed medium and authorizing the return of the printed medium based on the first unique identification code. In addition, the example method includes generating a second unique identification code for association with the printed medium for authorizing access to the supplemental material if the first unique identification code is valid and failing to generate the second unique identification code if the first unique identification code is invalid.

An example system to authorize access to supplemental material to a printed medium upon resale of the printed medium disclosed herein includes a generator to include a first unique identification code with the printed medium and a verifier to authorize the return of the printed medium based on a validity status of the first unique identification code. The generator also includes a second unique identification code for association with the printed medium to authorize access to the supplemental material if the first unique identification code is valid, and the generator to fail to generate the second unique identification code if the validity status of the first unique identification code is invalid.

Example tangible machine readable media having instructions to authorize access to supplemental material to a printed medium upon resale of the printed medium are also disclosed herein. Some example instructions, which when executed, cause method to at least include a first unique identification code with the printed medium and authorize the return of the printed medium based on the first unique identification code. The example instructions cause a machine to generate a second unique identification code for association with the printed medium for authorizing access to the supplemental material if the first unique identification code is valid and fail to generate the second unique identification code if the first unique identification code is invalid.

The examples disclosed herein enable publishers to identify and validate printed media that are legally produced reproductions and, thus, reduce the possibility and/or opportunities for piracy and/or intellectual property theft. The examples described herein also enable publishers to sell access to supplemental content through a printed medium registration process. The example registration process also enables the publishers to control access to the supplemental content. Furthermore, the examples disclosed herein allow publishers an opportunity to obtain market research data via the example registration process to, among other things, gain a better understanding of who is purchasing their printed media. The examples disclosed herein also prevent a counterfeiter from producing unauthorized copies and returning them to a publisher for a refund or from purchasing copies of a printed medium in a relatively cheap market, moving the copies into another higher-priced market as grey market goods and then returning the copies in the second market for a refund at a higher amount than paid and, thus, at a profit.

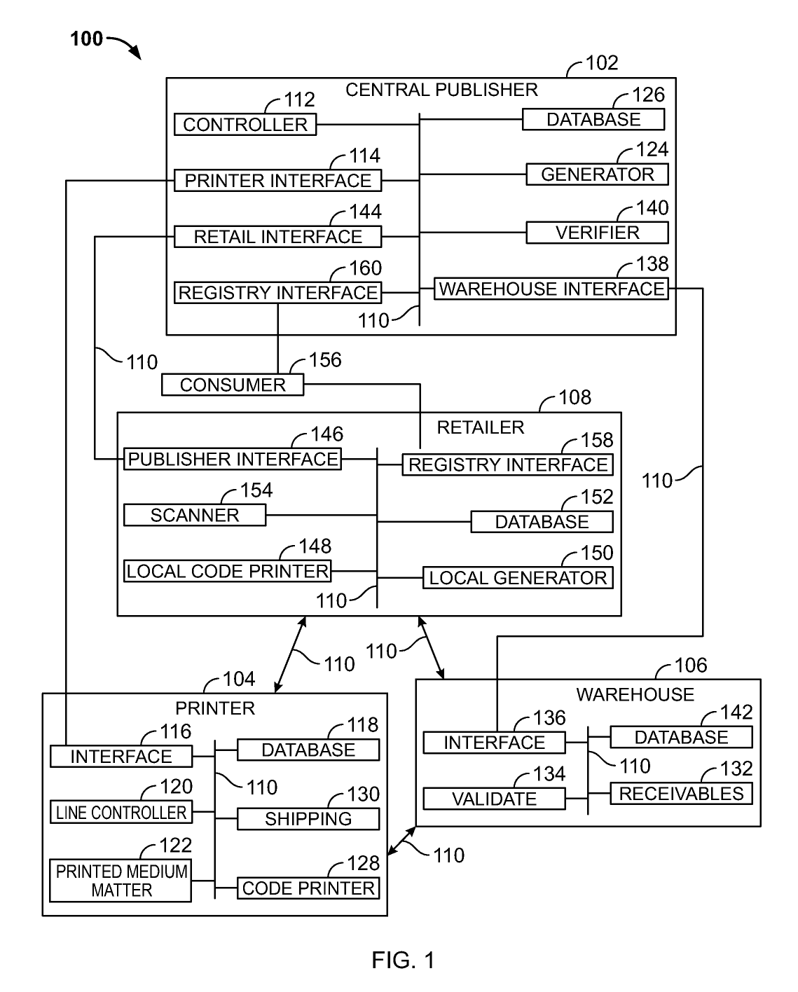

Turning now to the figures, FIG. 1 illustrates an example system 100 that may be implemented to prevent the return of an authorized copy of a printed medium, to provide access to supplemental content associated with the printed medium and/or to gather and maintain marketing data related to purchasers of the printed medium. Specifically, the example system 100 includes a central publisher 102, a printer 104, a warehouse 106 and a retailer 108. The central publisher 102, the printer 104, the warehouse 106 and the retailer 109, and their respective components. are communicatively coupled via one or more bidirectional, interconnected communication lines 110, which may include for example, cable-based communications or wireless communications via any known communication medium. The communications may also be internet-based communications. In addition, any or all of the elements of the example system 100 may be combined without departing from this disclosure.

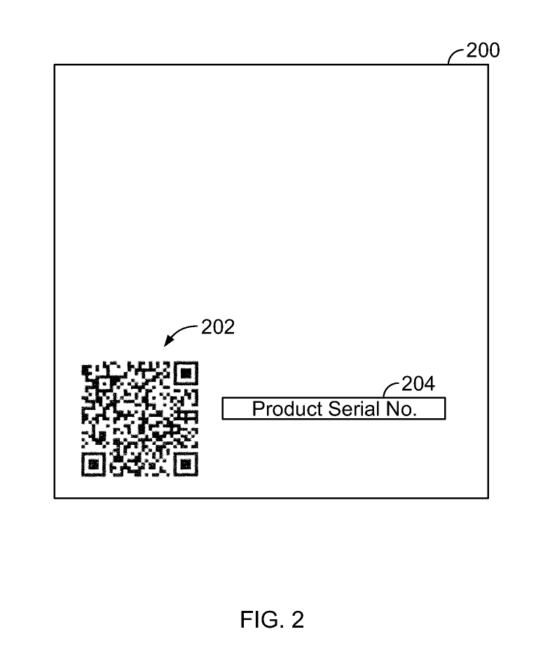

The example system 100 includes a controller 112 which creates and manages instructions and data for producing a printed medium such as, for example, the printed medium 200 of FIG. 2. The controller 112 communicates via a printer interface 114 and the communications lines 110 to the printer 104. The communications from the controller 112 of the central publisher 102 are received at the printer 104 via an interface 116. The instructions and related data may be stored in a local database 118. In addition, the instructions are used to control the line controller 120 and the printed medium printer 122 to produce the printed medium 200. The printed medium 200 may be any time of printed media including, for example, books, textbooks, magazines, newspapers, product literature, directories, business forms, labels, receipts, product packaging, boarding passes, passports, checks and check books, credit cards or any other item made from a printable substrate.

The example system 100 also includes a generator 124, which, in this example, is housed at the central publisher 102. The generator 124 generates one or more unique identification codes 202 for inclusion with the printed medium 200. The unique identification code 202 is different than a product identification code 204 included with the printed medium 200. The unique identification code 202 is separate from the product identification code 204 in that the product identification code 204 identifies a type of printed medium and the unique identification code 202 is associated with the printed medium 200 and not associated with other printed media having the same product identification code 204. Thus, identification code 202 allows for tracking of each individual printed medium.

The generator 124 generates the unique identification code 202 and a copy of the unique identification code 202 is stored in a database 126. A plurality of unique identification codes created by the generator 124 are stored in the database 126. Thus, the database forms a registry of genuine, valid or authentic unique identification codes. The unique identification code 202 may be one or more of a sequence of alpha numeric characters, a two-dimensional bar code, a quick response (QR) code (see FIG. 2), any other human or machine readable code or any combination thereof. In addition, the unique identification code 202 may include information such as, for example, a publisher's name, a book title, geographic information related to a location where the printed medium was produced, a product identification number, a uniform resource locator (URL), a personal URL (PURL) and/or other data as desired. In addition, the database 126 may store, in addition to one or more unique identification codes, consumer data and any other information used, generated or otherwise employed by the example system 100, as described in greater detail below.

The central publisher 102 communicates via the printer interface 114 to the printer 104 one or more of the generated unique identification codes 202 for inclusion in one or more print media 200. The printer includes a code printer 128 to print or otherwise image the unique identification code 202 on the printed medium 200. The code printer 128 and printed medium printer 122 may be embodied in the same physical device, or may be separate. The unique identification code 202 may be imaged onto the print medium 200 using, for example, variable inkjet printing technology during the production process, i.e., at the printer 104. In addition, in some examples, the unique identification code 202 may include one or more security features including, for example, ultra-violet or other invisible (to human) inks, void pantographs and/or microprinting. Also, as detailed below, in some examples, the unique identification code 202 is programmed into a scannable tag associated with the printed medium 200. In this example, each unique identification code 202 is authorized or authenticated as a valid code when the printed media 200 leave the printer 104.

The printer 104 also includes a shipping center or interface 130 to facilitate shipping of the printed medium 200 to the warehouse 106 for distribution and/or the retailer 108 and entry of the coded printed medium 200 into the supply chain/market. The unique identification code 202, or an additional code, may be included with the printed medium 200 and may include information that associates the printed medium with a specific production run, carton, pallet, and/or shipment.

If the printed medium 200 remains unsold at the retailer 108, for example, for a predetermined amount of time, the retailer 108 returns the printed medium 200 to the publisher via, for example, the warehouse 106. The warehouse 106 receives shipments of printed media via a receivables center 132. The warehouse 106 may also receive unauthorized reproductions of printed media directly from counterfeiters. The warehouse 106 validates the received printed media using a validator 134. The example validator 134 may be, for example a scanner, a mobile device or any other suitable device that can read the unique identification code 202 and/or a computer program or other application that operates as described herein to authenticate the unique identification code 202. The validator 134 is in communication via the interface 136 at the warehouse 106 and a warehouse interface 138 at the central publisher with a verifier 140. The validator 134 sends information about the unique identification codes of the printed media returned to the warehouse 106. The warehouse 106 may also include a local database 142 for storage of unique identification codes received therein and/or of any other data that may be employed by the example system 100.

The verifier 140 compares the unique identification code 202 of the printed medium 200 upon the attempted return of the printed medium 200 with the plurality of genuine unique identification codes in the database 126 to determine if the unique identification code 202 is included in the database 126. The database 126, as described above, contains a master list of all the authorized, genuine unique identification codes including all codes that are legitimately in circulation. Thus, the central publisher 102 maintains a central registry of all the genuine codes and serves as a clearinghouse for establishing the authenticity of printed media associated with the codes. Only printed media bearing authentic, valid unique identification codes that are not duplicative are valid copies of print media, and only these printed media will be accepted for return. Thus, the verifier 140 provides a clearance status to authorize the return of the printed medium 200 when the unique identification code 202 appears in the database 126 and provide a clearance status to deny the return of the printed medium 200 when the unique identification code 202 does not appear in the database 126 or a printed medium 200 being the unique identification 202 has already been returned. Unique identification codes that do not appear in the database 126 and/or or duplicative are not valid and, therefore, an indication that the respective printed media associated therewith are counterfeit, i.e., non-authorized reproductions of the printed media. The counterfeit printed media may be removed from circulation. In addition, once it is known that a unique identification code 202 has been duplicated, the example system 100, for example the verifier 140, can mark the duplicated identification code 202 with an indication that printed media bearing the duplicated code are or are likely to be unauthorized reproductions.

Additionally or alternatively, the verifier 140 provides a clearance status to deny the return of the printed medium 200 when the unique identification code 202 appears in the database 126 but the geographic information associated with the unique identification code 202 does not match geographic information associated with a location of the attempted return of the printed medium 200. Further still, the verifier 140 may authorize a return of printed media to the wrong location, i.e., within a geographic area different than the geographic area of the production or intended distribution of the printed media but tie or set the refund price of the printed medium to the geographic area of the production or intended distribution of the printed media. For example, a retailer returning validly reproduced college textbooks bearing valid unique identification codes bought in and/or for the US market will receive a refund for the textbooks at US market rates. A counterfeiter returning illegally reproduced college textbooks bearing fake, duplicate or no unique identification codes will be denied a refund and the textbooks will be removed from circulation. An unscrupulous person returning in the US validly reproduced college textbooks bearing valid unique identification codes bought in and/or for the Indian market will either be denied a refund or offered a refund at Indian market rates. This refund differential scheme could apply between geographic areas and/or markets with similar costs (e.g., between the US and Canadian markets), across different geographic areas within the same country (e.g., the US Northeast and US South markets), and/or between intended consumers (e.g., not-for profit institutions and multi-national corporations). The production, wholesale and retail prices may be used to control the refund format.

The central publisher 102 may also communicate with the retailer 108 via a retail interface 144 at the central publisher 102 and a publisher interface 146 at the retailer 108. In some examples, the unique identification code 202 is associated with the printed medium 200 at the point of sale of the printed medium 200, i.e., at the retailer 108. In such example, the retailer 108 includes a local code printer 148 to receive and print a unique identification code generated by the generator 124. The retailer 108 may also include a local generator 150 that generates genuine unique identification codes for inclusion with a printed medium at the point of sale. The retailer 108 may also include a local database 152 for storage of unique identification codes and/or any other data for use by the example system 100. Additionally or alternatively, a series of genuine, validated unique identification codes may be provided to the retailer 108 on, for example, a roll of labels so the retailer 108 does not have to include the local code printer 148. In this example, each unique identification code 202 is authorized or authenticated as a valid code during or at the completion of the sales transaction of the associated printed medium 200. In addition, in some examples, a unique identification code 202 may be included with each printed medium 200 provided to a retailer 108, and the retailer 108 may validate the code at the point of sale. Codes that were not validated would appear to the verifier 140 as invalid and would not be subject to return, as described above.

In such configurations, the unique identification code 202 may be associated with the printed medium 200 on demand. Additionally or alternatively, the unique identification codes 202 may be provided on printed media 200 but remain inactivated until the point of purchase. At the register, for example, the unique identification codes 202 may be activated as valid codes that are legitimately in circulation. These approaches prevent a counterfeiter from, for example, going to a bookstore, scanning legitimate unique identification codes for legitimate books, printing the legitimate unique identification code on pirated or fake books and returning the illegitimate books for a refund. With unique identification codes printed and included with printed media at the point of sale or otherwise on demand or validated at the point of sale, a counterfeiter wishing to practice the unlawful scheme described above would be forced to track down legitimate copies of the printed media from individuals at widely distributed locations and attempt to capture legitimate unique identification codes.

In situations in which printed media is returnable at the retailer 108, retailer 108 also includes a scanner 154. The scanner 154 operates similar to the validator 134 of the warehouse 106 and is in communication with the verifier 140 to determine the authenticity of the unique identification code 202 and, thus, of the printed medium 200 associated therewith. Operation of the verifier 140 is described above.

In addition to providing an indication that the printed medium 200 is a valid, legitimate reproduction, the unique identification code 202 may also be used by a consumer 156 to access supplemental content, i.e., content in addition to the content provided in the printed medium 200. The consumer 156 can register via a registry interface 158 at the retailer 108. In addition, the consumer 156 can scan the unique identification code 202 with a mobile device (e.g., a mobile phone) or any suitable device that can read the unique identification code 202. The consumer can interact with the central publisher 102 via the registry interface 160 of the central publisher 102. In some examples, once scanned or captured, the unique identification code redirects the consumer 156 to, for example, a website for registration. When the consumer 156 registers the printed medium 200, i.e., via the unique identification code 202, certain other supplemental content may be made available to the consumer 156. For example is the printed medium 200 is a college textbook, the consumer 156 may gain access to supplemental practice questions, the professor's publications, past examinations, supplemental material for laboratory sections of the related course and any other material.

The example system 100 may also authorize access to supplemental material to a printed medium (e.g., the printed medium 200 of FIG. 2) upon resale of the printed medium 200. In this example, the generator 124, 150 includes the first unique identification code 202 with the printed medium 200. Then after the verifier 140 authorizes the return of the printed medium 200 based on a validity status of the first unique identification code 202, as described above, the generator 124, 150 generates a second unique identification code for association with the printed medium 200 to authorize access to the supplemental material. The generator 124, 150 does not generate the second unique identification code if the validity status of the first unique identification code 202 is not valid. In one example application, this system 100 may be used where a college textbook is sold back to a university bookstore and then resold to another student. The second student registers the book and then receives a second unique identification code, which may be used to access different supplemental material related, for example, to that specific professor, semester, etc. In addition, there is an opportunity to request additional payment from the second student to the publisher for access to the supplemental material. The second unique identification code may incorporate any or all of the features of the first unique identification code described herein.

As with the first unique identification code 202, the second unique identification code may be printed by the printer 148. In addition, in some examples, the first unique identification code 202 and/or the second unique identification code may be programmed by a programmer into a scannable tag associated with the printed medium 200. Example scannable tags include radio frequency identification (RFID tags), though any other suitable tag may work.

In addition, in some examples, the supplemental material is updatable. In some examples the generator 124, 150 deactivates the first unique identification code 202 upon the generation of the second unique identification code. Also, in some examples, the first unique identification code 202 and the second unique identification code are valid for a predetermined time period. For example, in the university example provided herein, the unique identification codes may be valid for only an academic semester or year. However, any length of time could be used.

In addition, when the consumer 156 registers the unique identification code 202 or the second unique identification code, a third, etc., the central publisher 102 may use the registry interface 158, 160 to communicate with the consumer 156 and request further information from the consumer 156 including demographic, financial, geographic, behavioral, interests, and any other information to mine further marketing data from the consumer 156. The data may be used by the publisher or any other party with access to such data to determine information about the consumer 156, upsell to the consumer, or otherwise market to or study the consumer 156.

In addition, the unique identification code 202 could be used for other purposes in addition to the verification applications described herein. For example where the unique identification code is a QR code, when the consumer 156 captures the QR code via, for example the scanner 154 and or a mobile device such as, for example, a camera on a mobile phone, the QR code, which may be encoded with a URL or PURL, will automatically initiate one or more actions on the mobile phone to bring the consumer 156 to a portal where the consumer 156 could register the unique identification code 202 and the printed medium 200 for access to supplement material as described above and to associate further information therewith including an account number, phone number, EIN number, indexing number, etc. The consumer 156 may be offered goods or services, a means to offer payment, to view or buy pay per view movies or events, pay a bill, watch a video, view an image, purchase or enroll in a subscription, consolidate bills, sign up for offers or coupons, print or download a boarding pass, be presented with links to further websites or networks with the ability to offer login information, provide authorization for a transaction, add funds to a prepaid card, check balances and other activities.

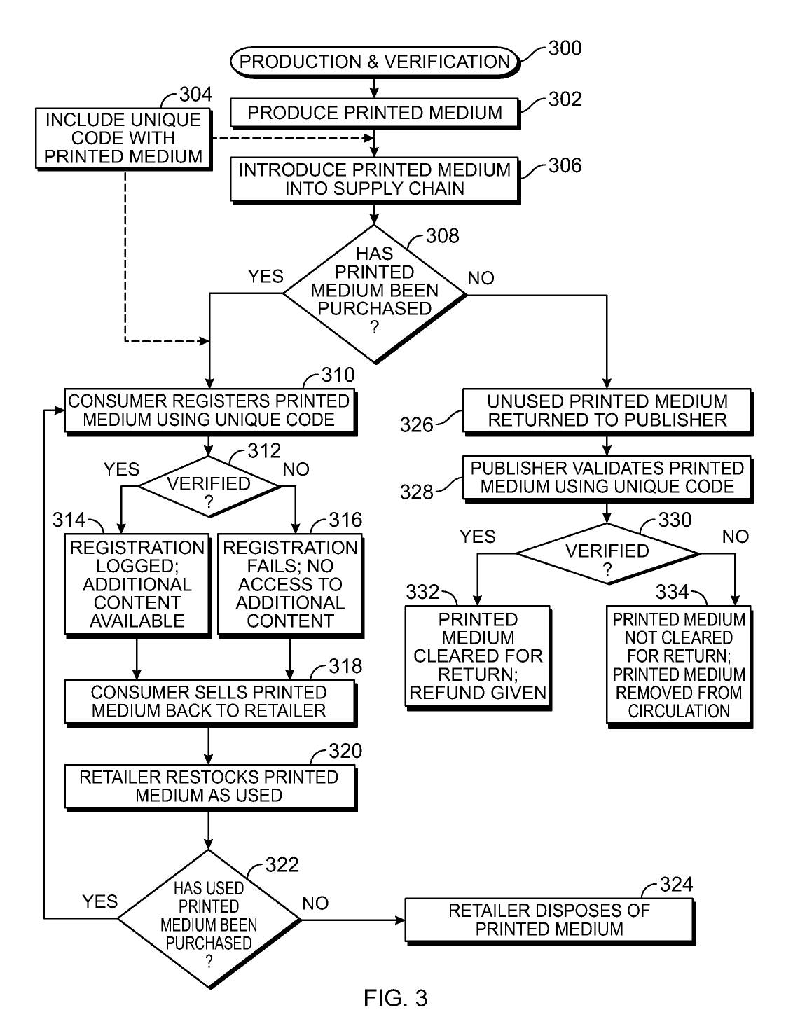

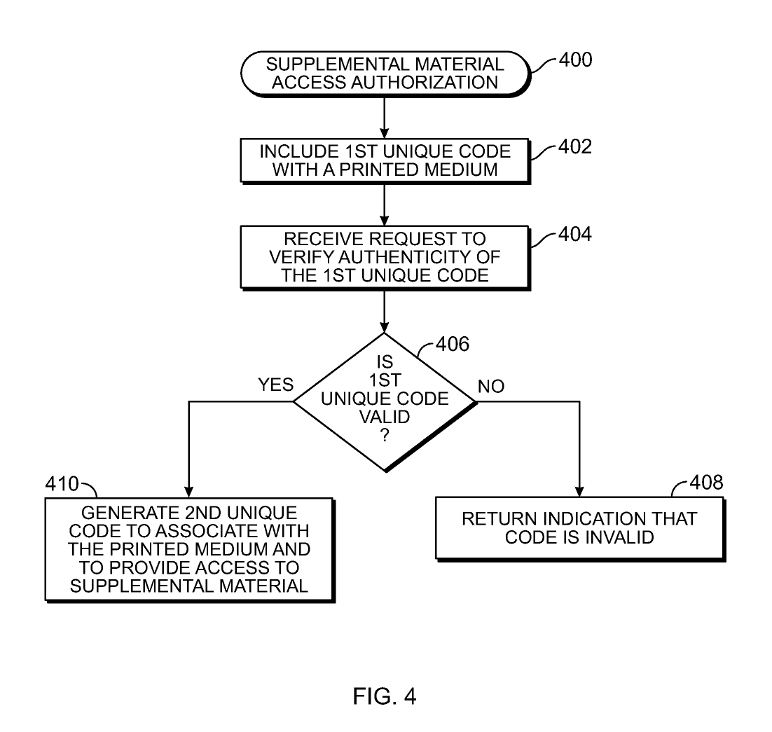

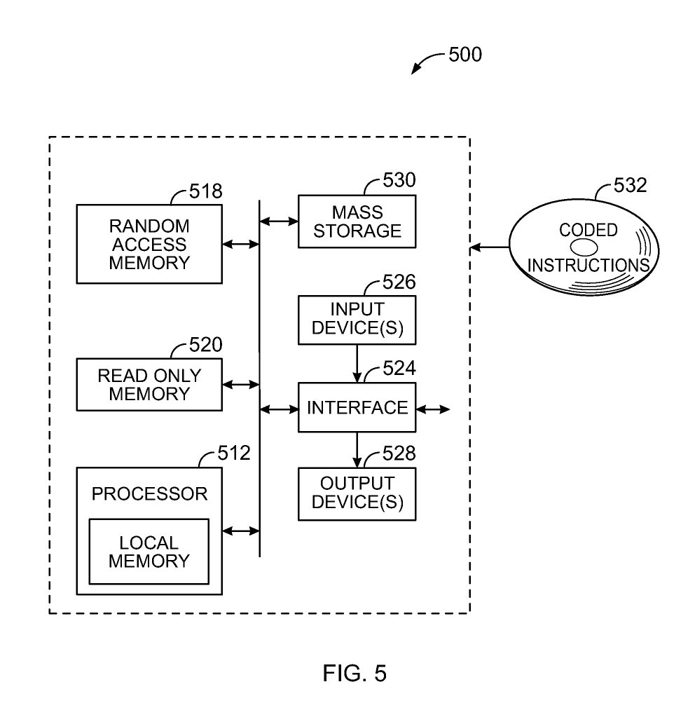

FIGS. 3 and 4 are flowcharts representative of example machine readable instructions that may be executed to implement the example system 100, the example central publisher 102, the example printer 104, the example warehouse 106, the example retailer 108, the example controller 112, the example generators 124, 150, the example verifier 140, the example validator 134, the example code printers 128, 148, the example scanner 154 and other components of FIG. 1. In the examples of FIGS. 3 and 4, the machine readable instructions comprise a program for execution by a processor such as the processor 512 shown in the example computer 500 discussed below in connection with FIG. 5. The program may be embodied in software stored on a computer readable medium such as a CD-ROM, a floppy disk, a hard drive, a digital versatile disk (DVD), or a memory associated with the processor 512, but the entire program and/or parts thereof could alternatively be executed by a device other than the processor 512 and/or embodied in firmware or dedicated hardware. Further, although the example program is described with reference to the flowcharts illustrated in FIGS. 3 and 4, many other methods of implementing the example system 100, the example central publisher 102, the example printer 104, the example warehouse 106, the example retailer 108, the example controller 112, the example generators 124, 150, the example verifier 140, the example validator 134, the example code printers 128, 148, the example scanner 154 and other components of FIG. 1 may alternatively be used. For example, the order of execution of the blocks may be changed, and/or some of the blocks described may be changed, eliminated, or combined.

As mentioned above, the example processes of FIGS. 3 and 4 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 3 and 4 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 3 illustrates an example method of production of a printed medium and verification of the authenticity of the printed medium (block 300). The example method 300 may be used to provide supplement content to the purchaser of legally reproduced copy of a printed medium and to prevent the return of an illegally reproduced copy of a printed medium. The example method 300 includes producing a printed medium (block 302) such as, for example via the example central publisher 102, printer 104, line controller 120 and printed medium printer 122 described above. A unique identification code such as, for example, the unique identification code 202 described above, may be included or otherwise associated with the printed medium (block 304) at this point. The printed medium is then introduced in the supply chain and then the market (block 306). The example method 300 determines if the printed medium has been purchased (block 308).

When the printed has been purchased, the unique identification code may be included at or around the point of sale (block 304). For example, the unique identification code could be associated with a purchased printed media at a sales register or via a mail-in process akin to ubiquitous mail-in rebates or warranty registrations.

After the purchase of the example printed media, the purchaser, e.g., a consumer, attempts to register the unique identification code (block 310) to access supplemental material associated with the printed medium. Upon the attempted return of the printed medium including the unique identification code, the example method includes verifying the inclusion of the unique identification code in a database of a plurality of genuine unique identification codes to verify the authenticity of the unique identification code (block 312) by, for example, the verifier 140 of FIG. 1. Based on the verification the example method provides a clearance status, wherein the clearance status indicates that the unique identification code is genuine and, therefore, registration is logged and additional or supplemental content is available for the consumer (block 314). Alternatively, where the clearance status indicates that the unique identification code is not genuine and that the printed medium associated therewith is a counterfeit reproduction, registration fails and no access to additional content is provided to the consumer (block 316). As indicated above, a unique identification code is valid when the unique identification code appears in a master list or central database of genuine unique identification codes such as, for example, the database 126 of FIG. 1. Also, the unique identification code is not valid when the unique identification code does not appear in the database.

In some examples, the consumer sells the printed medium back to the retailer (block 318), and the retailer restocks the printed medium for further resale as a used printed medium (block 320). After a predetermined time period, the retailer will determine if the restocked, used printed medium has been purchased (block 322). If the used printed medium has not been purchased, the retailer may dispose of the printed medium (block 324) by, for example, discarding the printed medium, donating the printed medium to a charity, or otherwise disposing of the printed medium. If the printed medium has been resold, the second consumer then attempts to register the printed medium via the unique identification code and control returns to block 310.

In the example method 300, if the original printed medium was never purchased (block 308), then unused printed medium are returned to the published (block 326) such as, for example, via the warehouse 106 of FIG. 1. The publisher validates the printed medium using the unique identification code (block 328). For example, the publisher may use the validator 134 and verifier 140 of FIG. 1 to determine if the unique identification code is valid and, therefore, if the printed medium is a legitimate reproduction (block 330). When the example method 300 determines that the unique identification code and the printed medium are authorized copies, then the printed medium is cleared for return and refund is given (block 332). When it is determined that the unique identification code is not genuine, i.e., that the associated printed medium is an authorized, illegitimate reproduction, then the printed medium is not cleared for return, no refund is given and the printed medium is removed from circulation (block 334). Other examples described above including, for example, refund rejections of legitimate printed medium and/or partial refunds provided based on geographic data included in the unique identification codes may be incorporated in addition or alternatively to the elements of the example methods described herein.

FIG. 4 shows another example method for verifying the authenticity of a printed medium and securing access to supplemental materials against counterfeiters (block 400) that may be implemented with the example system 100 of FIG. 1. In the example method 400 includes including a first unique code with a printed medium (block 402) such as, for example the unique identification code 202 and printed medium 200 as described above. The example method 400 includes receiving a request to verify the authenticity of the first unique code (block 404). The example method 400 determines if the first unique code is valid (block 406) using, for example, any of the aforementioned validation methods and/or structures. If is it is determined that the first unique code is invalid, then an indication to that effect is returned (block 408). However, if it is determined that the first unique code is valid and, therefore, that the printed medium is an authorized reproduction, then a second unique code is generated to associate with the printed medium and to provide access to supplemental material (block 410). The generation of the second code at this time prevents a counterfeiter or other unauthorized user from gaining access to the supplemental material. In addition, the generation of the second code for access to the supplemental material at this time provides greater control over what consumers have access to what material at what time. For example, a second verification of the first unique code may signal the expiration of a prior authorization period for a previously authorized consumer. In addition, the generation of the second code, third code, and so forth could be used to provide access to progressing generations or otherwise different supplemental materials.

FIG. 5 is a block diagram of an example computer 500 capable of executing the instructions of FIGS. 3 and 4 to implement the example controller 112, generator 124, 150, verifier 140, scanner 154, validator 134, code printers 128, 148 or any other suitable component of the example system of FIG. 1. The computer 500 can be, for example, a server, a personal computer, a mobile phone (e.g., a cell phone), a personal digital assistant (PDA), an Internet appliance, a set top box, or any other type of computing device.

The computer 500 of the instant example includes a processor 512. For example, the processor 512 can be implemented by one or more Intel® microprocessors from the Pentium® family, the Itanium® family or the XScale® family. Of course, other processors from other families are also appropriate.

The processor 512 is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is typically controlled by a memory controller (not shown).

The computer 500 also includes an interface circuit 520. The interface circuit 520 may be implemented by any type of interface standard, such as an Ethernet interface, a universal serial bus (USB), and/or a PCI express interface.

One or more input devices 522 are connected to the interface circuit 520. The input device(s) 522 permit a user to enter data and commands into the processor 512. The input device(s) can be implemented by, for example, a keyboard, a mouse, a touchscreen, a track-pad, a trackball, isopoint and/or a voice recognition system.

One or more output devices 524 are also connected to the interface circuit 520. The output devices 524 can be implemented, for example, by display devices (e.g., a liquid crystal display, a cathode ray tube display (CRT), a printer and/or speakers). The interface circuit 520, thus, typically includes a graphics driver card.

The interface circuit 520 also includes a communication device (e.g., the request servicer) such as a modem or network interface card to facilitate exchange of data with external computers via a network 526 (e.g., an Ethernet connection, a digital subscriber line (DSL), a telephone line, coaxial cable, a cellular telephone system, etc.).

The computer 500 also includes one or more mass storage devices 528 for storing software and data. Examples of such mass storage devices 528 include floppy disk drives, hard drive disks, compact disk drives, and digital versatile disk (DVD) drives. The mass storage device 528 may implement the storage database 118, 126, 142, 152.

The coded instructions of FIGS. 3 and 4 may be stored in the mass storage device 528, in the volatile memory 514, in the non-volatile memory 516, and/or on a removable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

1. A method of preventing the return of a printed medium including a product identification code and a unique identification code, the method comprising:
verifying inclusion of the unique identification code in a database of a plurality of genuine unique identification codes to verify authenticity of the unique identification code, wherein the product identification code identifies a type of printed medium, and wherein the unique identification code is associated with the printed medium and not associated with other printed media having the same product identification code; and
providing a clearance status based on the verification, wherein the clearance status authorizes the return of the printed medium when the unique identification code is valid and the clearance status denies the return of the printed medium when the unique identification code is invalid.

2. A method as defined in claim 1, wherein the unique identification code is valid when the unique identification code appears in the database and is not duplicative and the unique identification code is not valid when the unique identification code does not appear in the database or is duplicative.

3. A method as defined in claim 1, wherein the unique identification includes one or more of alphanumeric characters, a two-dimensional barcode, a quick response code or a uniform resource locator.

4. A method as defined in claim 1, wherein the unique identification code includes a security feature.

5. (canceled)

6. A method as defined in claim 1, wherein the unique identification code is registrable to provide access to supplemental content.

7. A method as defined in claim 1, further providing a second unique identification code for the printed medium after return of the printed medium.

8. A method as defined in claim 1, wherein the unique identification code includes geographic information indicative of the production location of the printed medium.

9. A method as defined in claim 8, wherein the clearance status denies the return of the printed medium when the unique identification code appears in the database and geographic information associated with the unique identification code does not match geographic information associated with a location of the attempted return of the printed medium.

10. (canceled)

11. (canceled)

12. (canceled)

13. A method as defined in claim 1, wherein the unique identification code is associated with the printed medium at the point of sale of the printed medium.

14. (canceled)

15. (canceled)

16. A method as defined in claim 1, wherein the unique identification code is generated at the point of sale of the printed medium.

17. A system to prevent the return of a printed medium including a product identification code and a unique identification code, the system comprising:
a generator to generate the unique identification code for inclusion with the printed medium, the unique identification code being separate from the product identification code, the product identification code identifying a type of printed medium and the unique identification code being associated with the printed medium and not associated with other printed media having the same product identification code;
a database to store the plurality of genuine unique identification codes; and
a verifier to compare the unique identification of the printed medium with the plurality of genuine unique identification codes in the database to determine if the unique identification code is included in the database and to provide a clearance status to authorize the return of the printed medium when the unique identification code appears in the database and to deny the return of the printed medium when the unique identification code does not appear in the database.

18. A system as defined in claim 17, wherein the unique identification includes one or more of alphanumeric characters, a two-dimensional barcode, a quick response code or a uniform resource locator.

19. A system as defined in claim 17, wherein the unique identification code includes a security feature.

20. (canceled)

21. A system as defined in claim 17, wherein the unique identification code is registrable to provide access to supplemental content.

22. A system as defined in claim 17, the generator to further provide a second unique identification code for the printed medium after return of the printed medium.

23. A system as defined in claim 17, wherein the unique identification code includes geographic information indicative of the production location of the printed medium.

24. A system as defined in claim 23, the verifier to further provide the clearance status to deny the return of the printed medium when the unique identification code appears in the database and geographic information associated with the unique identification code does not match geographic information associated with a location of the attempted return of the printed medium.

25. (canceled)

26. (canceled)

27. (canceled)

28. A system as defined in claim 17, wherein the unique identification code is associated with the printed medium at the point of sale of the printed medium.

29. (canceled)

30. (canceled)

31. A system as defined in claim 17, the generator to generate the unique identification code at the point of sale of the printed medium.

32. A tangible machine readable medium having instructions stored thereon, which when executed, cause method to at least:
generate a unique identification code for inclusion with a printed medium including a product identification code, the unique identification code being separate from the product identification code, the product identification code identifying a type of printed medium and the unique identification code being associated with the printed medium and not associated with other printed media having the same product identification code; and
compare the unique identification of the printed medium with a plurality of genuine unique identification codes stored in a database to determine if the unique identification code is included in the database and to provide a clearance status to authorize the return of the printed medium when the unique identification code appears in the database and to deny the return of the printed medium when the unique identification code does not appear in the database.

33-97. (canceled)
